(19) United States
(12) Patent Application Publication
(10) Pub. No.: US 2011/0019305 A1
(43) Pub. Date: Jan. 27, 2011

(54) MAGNETIC STORAGE DEVICE

(76) Inventors: Dieter Süss, Herzogenburg (AT); Thomas Schrefl, Herzogenburg (AT); Muhammad Asif Bashir, Sheffield (GB)

Correspondence Address: LADAS & PARRY LLP, 224 SOUTH MICHIGAN AVENUE, SUITE 1600, CHICAGO, IL, 60604, US

(21) Appl. No.: 12/509,540

(22) Filed: Jul. 27, 2009

(51) Int. Cl. G11B 5/127

(52) U.S. Cl. 360/110; G9B/5.04

(57) ABSTRACT

A magnetic storage device comprises a magnetic recording medium; a writing/reading element for storing information on the magnetic recording medium by generating a write field in order to switch regions within the magnetic recording medium in accordance with the information to be stored and reading stored information from the magnetic recording medium by sensing the switched regions within the recording medium and a layer-addressing means for addressing different layers of the magnetic recording medium by applying an oscillating magnetic layer address field in addition to the write field and by controlling the frequency of the oscillating magnetic field so that regions in different layers of the magnetic recording medium can be selectively switched and read.

### FIELD OF THE INVENTION

This invention relates generally to magnetic recording, and more particularly to thermally stable high density media as well as to a method of storing information on a magnetic recording medium.

### BACKGROUND OF THE INVENTION

At present, conventional data storage technologies, where individual bits are stored as magnetic units on the surface of a recording medium, are approaching physical limits beyond which individual bits may be too small and thermally unstable or too hard to write with the limited field from the write head. The theoretical limit is known as the superparamagnetic limit (Charap 1997) and various assist technologies (Rottmayer 2006, Zhu 2008) have been proposed to push this limit towards high area density. Storing information throughout the volume of a medium—not just on one layer—seems an alternative way to overcome this limitation. In recording on continuous bit patterned media, any excess in signal to noise ratio (SNR) would be used to record the bits at higher linear density. A further improvement in SNR can be achieved in bit patterned recording (Terris 2005). However, an increase of linear density may not be possible owing to fabrication restrictions in bit patterned media. If there is a limit in areal density, an obvious solution is going to 3D magnetic recording. Indeed, 3D writing of bit patterned media was demonstrated by Albrecht and co-workers (Albrecht 2005), They write on two layers with different anisotropy sequentially. First, the islands in both layers are switched by a high write current, then the low anisotropy layer only is written using a low write current (Khizroev 2006).

### DESCRIPTION OF THE INVENTION

### Brief Summary of the Invention

The invention proposes a device and a method to address different layers without the need of a specific write sequence.

A magnetic storage device according to the invention comprises

a magnetic recording medium;
a writing/reading element for storing information on the magnetic recording medium by generating a write field in order to switch regions within the magnetic recording medium in accordance with the information to be stored and reading stored information from the magnetic recording medium by sensing the switched regions within the recording medium and
a layer-addressing means for addressing different layers of the magnetic recording medium by applying an oscillating magnetic layer address field in addition to the write field and by controlling the frequency of the oscillating magnetic field so that regions in different layers of the magnetic recording medium can be selectively switched and read.

The invention allows for layer-selective writing of media with multiple storage layers. Selectivity is achieved by controlling the frequency of an oscillating magnetic layer address field in the GHz range, applied in addition to the write field of the magnetic writing/reading head.

According to an embodiment of the invention addressing of different layers of a magnetic recording medium can be achieved by applying a linearly polarized RF field oriented in the plane perpendicular to the easy axis of the magnetic medium (with uniaxial anisotropy) in addition to the conventional write field. Originally, Thirion and co-workers showed experimentally that magnetization reversal in hcp-Co nanoparticle is possible below the Stoner-Wohlfarth switching field in the presence of a microwave field that is tuned to a certain frequency (Thirion 2003). They proposed to use a RF assist field in magnetic recording to overcome the superparamagnetic limit. Zhu and co-workers used micromagnetic simulations to demonstrate microwave assisted magnetic recording in granular perpendicular media. Theoretical investigations show that the frequency of the microwave assist field has to be close to the ferromagnetic resonance frequency (Scholz 2008, Bertotti 2001, Bashir 2008, Thirion 2003)

According to a further embodiment of the invention the generation of the oscillating magnetic layer address field in the GHz or microwave range is realized by means of a wire next to the tip of a single pole writing head. The Oersted field from the alternating current induces magnetic oscillations in the pole tip which create a high frequency field that is superimposed to the perpendicular write field.

### BRIEF DESCRIPTION OF DRAWINGS

The foregoing discussion will be understood more readily from the following detailed description of the invention, when taken in conjunction with the accompanying drawings, in which

FIG. 1. is a schematic sectional view of an embodiment of a recording structure according to the invention with multiple recording layers.

FIGS. 2 a, 2b and 2c show the selective writing on patterned recording media with rf-fields.

FIGS. 3 a, b and d show phase diagrams of switching. FIG. 3a the frequency dependence of the write field amplitude for an upper layer, FIG. 3b a sketch of an upper and lower layer island and the strength of the RF field amplitude, numbers are distances in nm, FIG. 3c the frequency dependence of the write field amplitude for a bottom layer, FIG. 3d the frequency dependence of the write field of a bottom layer with 5% higher anisotropy.

FIGS. 4a and b show computed bit error rates. FIG. 4a: Error rate for writing on the top and bottom layer as function of down track phase (standard deviation of the anisotropy is K=0.03). FIG. 4b: Computed error rates for different width of the anisotropy distribution.

FIGS. 5a and b show the selective writing on multilayer granular media with rf-fields.

FIGS. 6a and b show an embodiment of a recording head producing the perpendicular write field and a rf-field in accordance with the invention, where FIG. 6a is a detail of FIG. 6b

FIG. 7. shows the head field generated by the recording head of FIG. 6a and FIG. 6b.

FIG. 8 shows a read back signal of three different states S1, S2 and S3.

### DETAILED DESCRIPTION

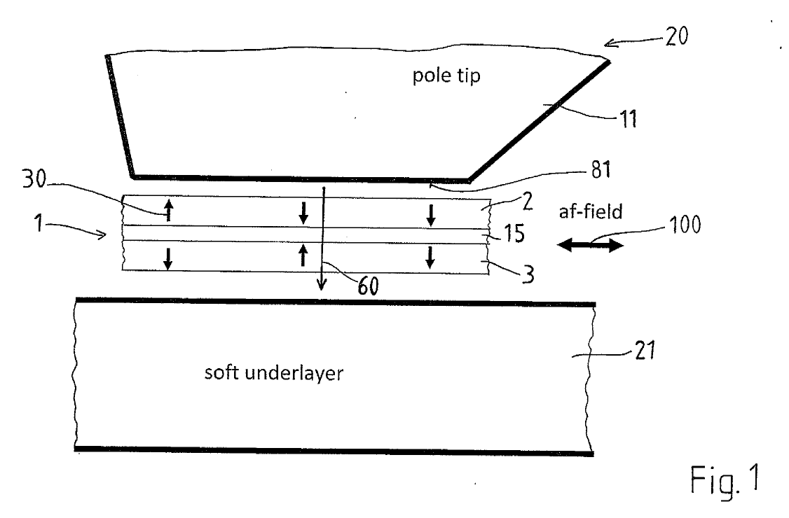

FIG. 1 schematically shows the structure that allows for magnetic data or information storage on multiple layers. A recording medium 1 is composed of two magnetic layers, an upper layer 2 and a bottom layer 3. Switchable magnetic elements 30 within the layers 2, 3 are schematically indicated by arrows 30. Further, a soft underlayer 21 is shown, which is commonly used in perpendicular recording in order to increase the write field. The invention, however is not restricted to two layers but can be applied, if necessary also to three and more layers.

The recording or writing process requires at least two field components:
(i) a magnetostatic write head field 60 which acts primarily perpendicular to the recording medium 1, which is generated by a recording head 20 similar to state of the art perpendicular recording heads of which a pole tip 11 is shown in FIG. 1.
(ii) (ii) an oscillating magnetic layer address field, i.e. microwave field 100 that assists the recording process. The recording medium 1 is designed that no data can be written without the microwave layer address field 100. Due to the microwave layer address field 100 each layer 2, 3 will be addressed by distinct frequency bands in the range of about 50 MHz to 200 GHz. These frequency bands do not overlap if the magnetic anisotropies of the layers are sufficiently different. A high magnetic anisotropy is selected for the upper layer 2 as it does face a higher field from the head 20 due to lower distance from air bearing surface 81 (ABS) and vice versa. This naturally leads to two different resonance frequencies for microwave assisted switching. The reduction of the energy barrier of the bottom layer 3 owing to the lower magnetocrystalline anisotropy in the bottom layer 3 is compensated by increasing its thickness. The multilayer islands can be fabricated with a nonmagnetic layer 15 in between the two layers 2, 3 which helps to avoid strong interactions between the two magnetic layers 2, 3. Alternatively, an antiferromagnetic coupling between the layers 2, 3 can be introduced in order to compensate for the parallel coupling due to the strayfield interaction as proposed by Albrecht et al⁵.

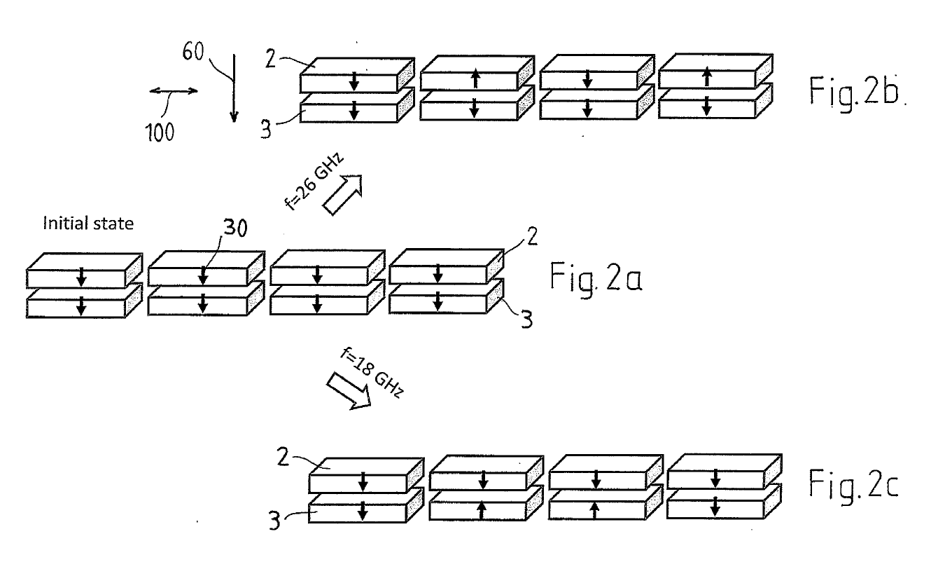

In the following we will demonstrate recording on either the upper layer 2 or the lower layer 3. Initially, it is assumed that all magnetic elements 30 within the layers 2, 3 have a magnetization pointing down as shown in FIG. 2a.

In the first experiment a bit pattern of 0101 (down, up, down, up) should be written in the center track at the upper layer 2. This was demonstrated if in addition to the perpendicular head field 60, which applied a head field sequence of down, up, down, up a horizontal layer address RF-field 100 with 26 GHz was superimposed as shown in FIG. 2b. Without layer address RF-field 100 no element was reversed.

If a RF-field with 18 GHz was superimposed, as shown in FIG. 2c, the pattern (down, up, down, up) could be written in the bottom layer 3. Possible methods to create a microwave layer address field are discussed in the last section of this specification.

The hard magnetic elements suitable as a recording medium 1 that stores the information may be formed from any material that has large perpendicular anisotropy.

These materials include without limitation of the scope of the invention tetragonal: L10-ordered phase materials, CoPt and FePt based alloys, CoPtCr alloys, including CoPtCrB, CoPtCrTa, and CoCr based granular media.

Other high anisotropy materials suitable for the recording medium include pseudo-binary alloys based on the FePt and CoPt L10 phase, i.e., FePt—X and CoPt—X, where the element X may be Ni, Au, Cu, Pd or Ag, as well as granular composite materials such as FePt—C, FePt—ZrO, FePt—MgO, FePt-B203, materials containing at least one of B, Cu, Ag, W, Mo, Ru, Si, Ge, Nb, Pd, Sm, Nd, Dy, Hf, Mn, Ni and other similar composites.

The difference in the anisotropy of the different layers can be realized by different composition of the alloys thus the recording medium comprises two or more layers of different material parameters. With respect to the embodiment of FIG. 1 the upper layer 2 is composed of a different composition than the lower layer 3. Anisotropy in each layer 2, 3 is adjusted to match the writing field.

Using Co/Pd multilayers the strength of the magnetic anisotropy and coercivity of the film can be altered by varying the thickness of each Co and Pd layer (Carcia 1985). As an example the required properties for multilayer recording is achieved by the following Co/Pd multilayer stack, separated by a 5-nm Pd layer [Co(2 Å)/Pd(5.5 Å)]₆/Pd(50 Å)/[Co(3.3 Å)/Pd(10 Å)]₅

Another realization of a multiple recording structure with different anisotropies within the layers bases on CoCrPt films. By changing the Pt content the anisotropy of the alloy can be changed by one order of magnetite (Jung 2007). For the upper layer a hard magnetic CoCr₁₈Pt₁₂ film can be used. The anisotropy of the bottom layer can be reduced by a factor of 4 by decreasing the Pt to 4%.

For ultra high density recording the extremely hard magnetic alloy L10-FePt can be used for the upper layer. In order to improve the writeability this high coercive alloy may be exchange coupled to a soft magnetic layer in order to decrease the writefield by forming an exchange spring structure (Suess 2005). The bottom layer can also be formed out of an L10-FePt alloy. In order to control the coercivity in the bottom layer a soft magnetic layer exchange coupled to the hard magnetic alloy can be used, too. By using a thicker soft magnetic layer in the bottom layer than in the upper layer the coercivity of the bottom layer is smaller than in the top layer. Another embodiment of the invention can thus be realized by one or more of the magnetic recording layers being exchange coupled to softer magnetic layers in order to form exchange spring structures.

In FIG. 2a-2c for selectively writing on a patterned magnetic recording media a linearly polarized microwave field (with an amplitude H₁) is applied perpendicular (parallel to the y-axis) to the anisotropy direction. The writing device as described in connection with FIG. 1 is similar to the write head used in high density recording simulations on graded media (Goncharov 2007), with the same pole tip flair angles but a reduced width of 20 nm. The media parameters are set as followings, upper layer anisotropy K_{u,upper}=0.21 MJ/m³, bottom layer anisotropy K_{u,bottom}=0.142 MJ/m³, exchange constant A=10⁻¹¹ J/m, magnetic polarization J_{S}=0.2 T, and Gilbert damping constant α=0.05. The layer thicknesses are tᵤₚₚₑᵣ=2.4 nm and t_{bottom}=3.5 nm, the non-magnetic gap between the layers is g=3.6 nm, and the lateral extension of the island is I²=20×20 nm². The computed energy barrier (Dittrich 2002) of one bit is E_{B,top}=46 k_{B}T(300K) for the upper layer and E_{B,bottom}=48 k_{B}T(300K). When the RF field is generated by a microwave source near the ABS, the RF field amplitude will be higher in the upper layer 2 and lower in the bottom layer 3. For the design of a RF field source described below the RF field amplitude was |H_{1,upper}|=0.13 T at a distance of 2 nm below the ABS (at the top surface of the upper layer) and |H_{1,bottom}|=0.072 T at a distance of 11.5 nm below the ABS (at the bottom surface of the bottom layer).

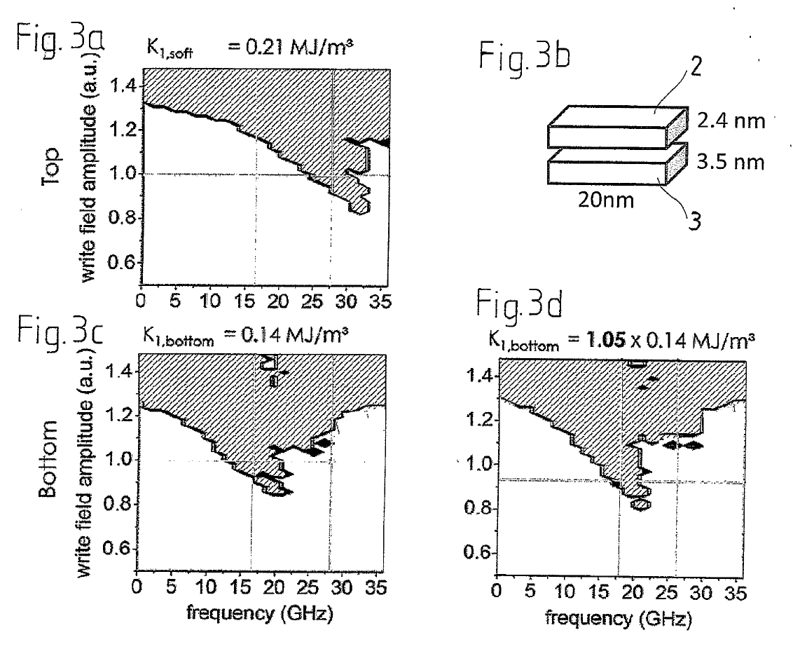

FIGS. 3a, 3c and 3d show write simulations that were performed on a single two-layer magnetic recording island as function of write field strength and RF field frequency. In the calculation of the phase diagrams presented in FIGS. 3a, 3c and 3d the island is exposed to the static field of a magnetic writing head moving with a velocity of 20 m/s and to an oscillating magnetic layer address RF field which is uniform in the xy-plane and decreases linearly with increasing distance from the ABS with a gradient of 4.3 mT/nm.

The precomputed static write field is scaled to mimic a head field rise time of 0.1 ns FIG. 3b shows the schematic island geometry with upper layer 2 and bottom layer 3. FIG. 3a shows the phase diagram of switching of the upper layer 2. For large write field amplitudes the upper layer 2 can be switched irrespective of the RF field frequency. However, these large write field amplitudes cannot be reached with a real head. For a write field scaling factor of one (this corresponds to a perpendicular write field of 1.25 T after applying a write current of 50 mA for 1 ns) switching of the upper layer is only possible when the address layer RF field frequency is within a band of 25 GHz to 29 GHz. At these particular frequencies, switching of the bottom layer 3 is not possible.

The results shown in FIG. 3c show that the bottom layer 3 can only be switched for RF frequencies of the oscillating magnetic layer address field between 14 GHz and 19 GHz. Generally, the frequency bands for successful switching becomes smaller with decreasing write field amplitude. From the simulations we derived the target frequencies of 28 GHz for writing on the upper layer 2 and 16 GHz for writing on the bottom layer 3. The frequency bands for switching vary with the materials to be switched and can be adapted accordingly.

A change of 5 percent in the anisotropy has only a small effect on the shape of the phase diagram. For example, it is possible to switch the bottom layer 3 with an RF frequency of 16 GHz after a change in the anisotropy to Kᵤ*_{,bottom}=1.05×0.142 MJ/m³ as shown in FIG. 3d.

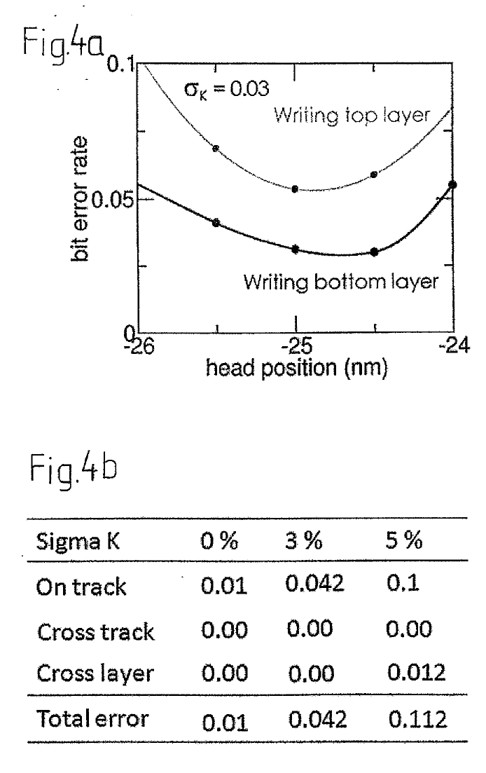

Using the layer address frequencies for the different layers we computed the bit error rate from recording on an array of 4×3 islands (24 bits) with a periodicity of 25 nm. We did 200 runs with differently prepared initial states drawing the anisotropy from a Gaussian distribution and using a random initial magnetization for the bits. The target bit patterned was 0101 on the 4 islands in the center track. All 12 islands were randomly magnetized up or down before starting a recording giving random adjacent track patterns. The 200 runs were repeated three times: (1) no anisotropy distribution, random initial magnetization; (2) standard deviation of the anisotropy K=0.03, random initial state, and (3) K=0.05, random initial state. The table in FIG. 4b gives the on track errors (a bit is not written or switched back), cross-track errors (a cross-track bit in the target layer is accidentally switched), and the cross-layer errors (a cross-layer bit is accidentally written), and the total error for all recorded bits. For K=0 no cross-track and no cross-layer errors were found for a total of 1600 bits. These errors arise from the magnetostatic interaction field within the array. The total error rate is 0.01. For K=0.03 the error rate increases to 0.042. Only if the standard deviation of the anisotropy is increased to K=0.05 cross-layer write errors are observed (see FIG. 4). Schabes showed that the write error in bit patterned media shows a pronounced minimum as function of the down-track phase (Schabes 2008). FIG. 4a shows that the optimal down track phase depends on whether we want to address the top or the bottom layer. For simplicity the error rates presented in the table were computed for a fixed down track phase (head position of −25 nm). Comparing the different types of write errors, we conclude that the 3D storage does not severely increase bit error rate as compared to microwave assisted recording on single layer bit patterned media. This was confirmed by performing error rate computations on a single layer. The cross layer error rate is small as compared to the on track error rate. Here the origin of the error is the on track addressability. The on track error rate is caused by the switching field distribution. The comparison of the error rate for K=0.0 and K=0.03 shows that the switching field distribution due to variations in anisotropy is greater than that caused by magnetostatic interactions. A change of the write pattern, which will change the magnetostatic interaction field, will not significantly alter the computed error rates. Improvements in the field gradients (write field and/or RF field) will reduce the bit error rate. By creating a spatially constrained RF field, Zhu and co-workers³ showed sharp bit transitions in microwave assisted recording on granular media. In their concept writing is governed by the field gradient of the RF field. Here we used a RF field that is uniform in the plane of the data layer. In our simulations addressability is governed by the field gradient of the static writer.

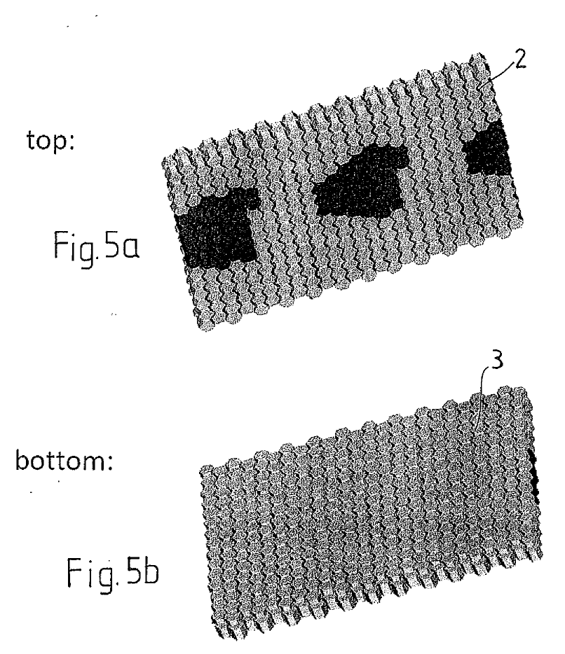

In all previous examples recording was performed on patterned media. FIGS. 5a and 5b show multilayer recording on a granular magnetic film with two layers with different anisotropies. The magnetic properties are as follows: magnetic polarization Js=0.5 T, exchange constant within a grain A=10⁻¹¹ J/m, the exchange between grains is reduced to A=10⁻¹⁴ J/m in a 1 nm thick phase. The anisotropy constant is K₁=0.48 MJ/m³ in the upper layer and K₁=0.28 MJ/m³ in the bottom layer. FIGS. 5a and 5b show that the upper layer 2 and the bottom layer 3 can be selectively written by applying an address layer RF field of 8 GHz and 4 GHz, respectively. The two layers 2, 3 can be either magnetically decoupled, so that no exchange interaction exists between the two layers 2, 3. However, in order to compensate for the de-magnetizing field of each layer it will be beneficially to introduce an exchange coupling layer between the two magnetic layers 2, 3. This can be realized for example by a thin (0.1-5 nm) Ruthenium layer.

Zhu and co-workers³ proposed a spin torque oscillator as RF field source.

Alternatively, an address layer RF field can be produced exciting high frequency oscillations of the magnetization in the pole tip of a single pole write head.

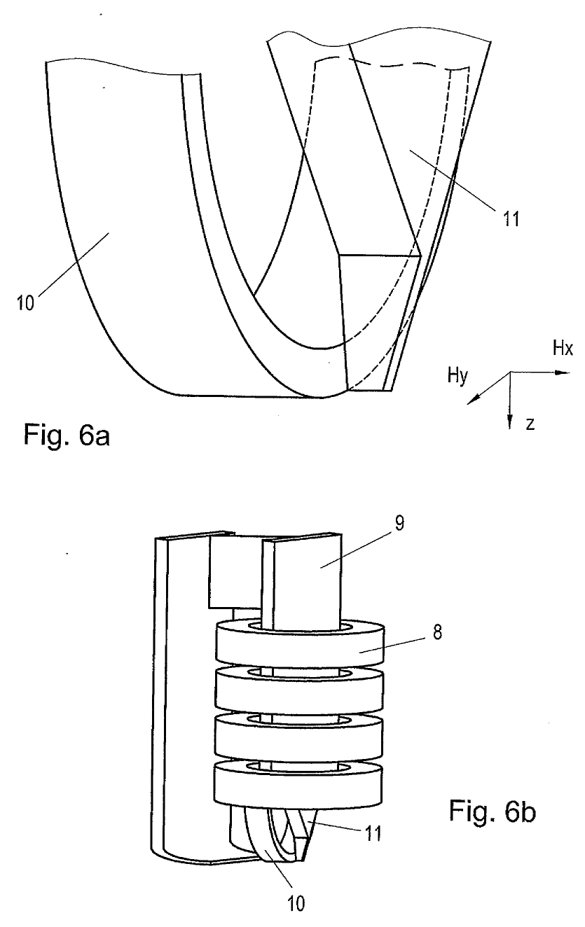

FIGS. 6a and 6b show a writing device according to the invention, in particular a recording head 9 where a secondary coil 10 in form of a wire loop or a strip wire next to the pole tip 11 is placed. An AC-current with a density of 5×10¹² A/m² through the secondary coil 10 creates an Oersted field that causes the magnetization in the pole tip to rotate around its equilibrium position.

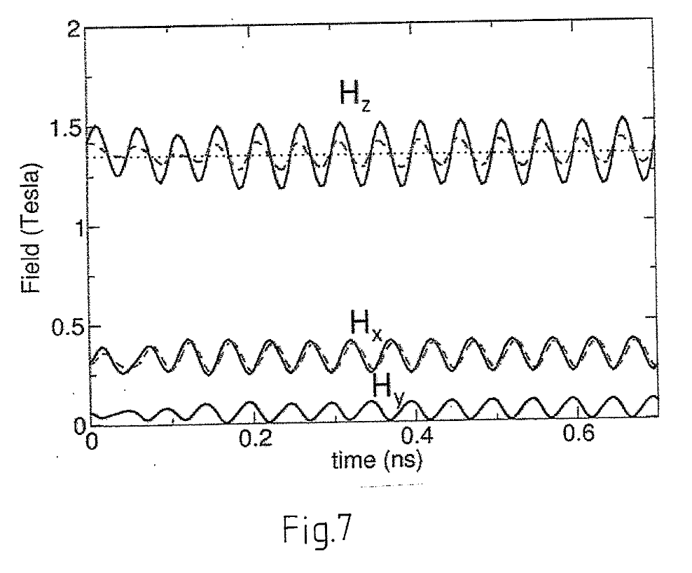

FIG. 7 shows the total magnetic field created by a writing head with a constant write current through the primary coil 8. The field components (FIG. 7) are evaluated at the point (3.2 nm, −1.6 nm, −2.65 nm) whereby the origin of the Cartesian coordinate system is placed at the center of the trailing edge of the pole tip. The total magnetic field is the sum of the Oersted field which is used as the layer address field from the secondary coil 10 and the magnetostatic field from the soft magnetic parts of the writing head 9 including the soft under layer (not shown in FIGS. 6a, 6b) and pole tip 11. The Oersted field drives the magnetization in the pole tip 11 with the frequency of the current in the secondary coil 10. As a consequence the magnetostatic field, which is the field created by the magnetization in the writing head 9, oscillates with this frequency.

In FIG. 7 the dashed lines are the field components Hx, Hy, Hz of the magnetostatic field and the solid lines are the sum of the magnetostatic field and the oscillating address layer field or Oersted field. Thus, the write field is a superposition of a static field and a high frequency field. In particular we see a strong in plane component of the high frequency field with an amplitude of 96 mT at a distance of 2.65 nm from ABS, which is sufficiently large to support microwave assisted switching.

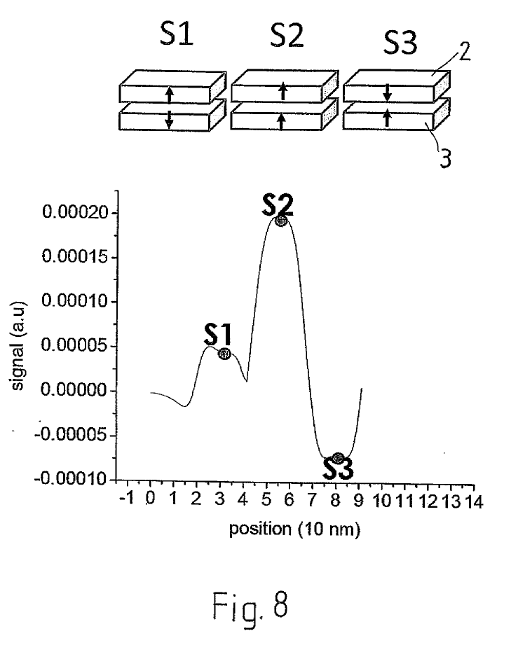

FIG. 8 shows the read back signal for the three states S1, S2 and S3. The full width half maximum of the reader sensitivity function is 8 nm in the down track direction and it is 12.5 nm in the cross track direction. The signal level depends on the magnetic state of the two islands below the reader. Four possible states are clearly distinguishable. If the signal level of the state up/up (both bits up) is s_{u,u}=0.5 and the signal level of down/down is s_{d,d}=−0.5, then the signal levels of the other states are as follows: up/down (top bit up, bottom bit down) s_{u,d}=0.125 and down/up s_{d,u}=−0.125. A further way to read back the three-dimensional information is possible moving the head out of the center of the target track or using multiple read heads. By moving the head in cross track direction we change the reader sensitivity function to become more sensitive to the bottom layer. If the reader is moved cross track by 10 nm, the signal from the upper layer decays by 55 percent, whereas the signal from the bottom layer decays by 48 percent. Then the distance from the center of the neighboring track is 15 nm. The signals that are picked up from the neighboring tracks are 3 and 16.5 percent of the full signal from the upper layer and bottom layer, respectively. Indeed, this 3D read back will be similar to information gathering in nuclear magnetic resonance imaging.
S. H. Charap, P.-L. Lu, and Y. He, IEEE Transactions on Magnetics 33, 978-983 (1997).
R. Rottmayer, S. Batra, D. Buechel, W. A. Challener, J. Hohlfeld, Y. Kubota, L. Li, B. Lu, C. Mihalcea, K. Mountfield, K. Pelhos, C. Peng, T. Rausch, M. A. Siegler, D. Weller, and X. M. Yang, IEEE Transactions on Magnetics 42, 2417 (2006).
J. G. Zhu, X. Zhu, and Y. Tang, Magnetics, IEEE Transactions on 44, 125-131 (2008).
B. D. Terris and T. Thomson, Journal of Physics D-Applied Physics 38, R199-R222 (2005).
M. Albrecht, G. Hu, A. Moser, O. Hellwig, and B. D. Terris, Journal of Applied Physics 97, 103910 (2005).
S. Khizroev, Y. Hijazi, N. Amos, R. Chomko, and L. D., Journal of Applied Physics 100, 063907 (2006).
C. Thirion, W. Wernsdorfer, and D. Mailly, Nat. Mater. 2, 524 (2003).
W. Scholz and S. Batra, Journal of Applied Physics 103, 07F539 (2008).
G. Bertotti, C. Serpico, and I. D. Mayergoyz, Physical Review Letters 86, 724-727 (2001).
M. A. Bashir, T. Schrefl, J. Dean, A. Goncharov, G. Hrkac, S. Bance, D. Allwood, D. Suess, IEEE Transactions on Magnetics 44, 3519 (2008).
A. Goncharov, T. Schrefl, G. Hrkac, J. Dean, S. Bance, D. Suess, O. Ertl, F. Dorfbauer, and J. Fidler, Applied Physics Letters 91, 222502 (2007).
R. Dittrich, T. Schrefl, D. Suess, W. Scholz, H. Forster, and J. Fidler, J. Magn. Magn. Mater. 250, 12-19 (2002).
M. E. Schabes, Journal of Magnetism & Magnetic Materials 320, 2880-2884 (2008)
P. F. Carcia, A. D. Meinhaldt, and A. Suna, Applied Physics Letters, 47, 178-180 (1985)
H. Jung, E. Velu, S. Malhotra, U. Kwon, D. Suess, and G. Bertero, IEEE Transactions on Magnetics, 43, 2088-2090 (2007).
D. Goll and A. Breitling, Applied Physics Letters, 94, 052502-3 (2009).
D. Suess, T. Schrefl, S. Fahler, M. Kirschner, G. Hrkac, F. Dorfbauer, and J. Fidler, Applied Physics Letters, 87, 012504-3 (2005).

1. A magnetic storage device, comprising:
a magnetic recording medium;
a writing/reading element for storing information on the magnetic recording medium by generating a write field in order to switch regions within the magnetic recording medium in accordance with the information to be stored and reading stored information from the magnetic recording medium by sensing the switched regions within the recording medium and
a layer-addressing means for addressing different layers of the magnetic recording medium by applying an oscillating magnetic layer address field in addition to the write field and by controlling the frequency of the oscillating magnetic field so that regions in different layers of the magnetic recording medium can be selectively switched and read.

2. A magnetic storage device according to claim 1, wherein the write field is generated by a pole tip of a magnetic recording head located within a distance from the surface of the magnetic recording medium.

3. A magnetic storage device according to claim 1, wherein the layer addressing means is a strip wire.

4. A magnetic storage device according to claims 2 and 3, wherein the strip wire is located in the vicinity of the pole tip of the magnetic recording head.

5. A magnetic storage device according to claim 1, wherein the layer address field produced by the layer-addressing means is a linearly polarized RF field in the GHz range.

6. A magnetic storage device according to claim 1, wherein the magnetic recording medium has an perpendicular easy axis of magnetization.

7. A magnetic storage device according to claims 3 and 4, wherein the linearly polarized RF field is oriented in the plane perpendicular to the easy axis of the magnetic medium.

8. A magnetic storage device according to claim 1, wherein the layer address field has a magnetic field amplitude an order of magnitude lower than the write field.

9. A magnetic storage device according to claim 1, wherein the magnetic recording medium comprises two or more layers of different material parameters.

10. A magnetic storage device according to claim 1, wherein one or more of the magnetic recording layers are exchange coupled to softer magnetic layers in order to form exchange spring structures.

11. A magnetic storage device according to claim 9, wherein the material parameters are one of a uniaxial anisotropy constant, a magnetic polarization, an exchange constant and a gilbert damping constant or a combination thereof.

12. A magnetic storage device according to claim 9, wherein the magnetic recording medium has an upper layer close to the writing/reading element and the layer addressing means and a bottom layer being distant from the writing/reading element and the layer addressing means.

13. A magnetic storage device according to claim 10, wherein the bottom layer has a higher thickness than the upper layer.

14. Use of a magnetic storage device according to one of the previous claims in a magnetic hard disk.

15. A method of storing information on a magnetic recording medium by
applying a magnetostatic write field and an oscillating magnetic layer address RF field in addition to the write field and
controlling the frequency of the oscillating magnetic layer address field so that regions in different layers of the magnetic recording medium can be selectively switched and read.
